(19) United States
(12) Patent Application Publication
(10) Pub. No.: US 2009/0221338 A1
(43) Pub. Date: Sep. 3, 2009

(54) PHYSICAL EXERCISE VIDEO GAME METHOD AND APPARATUS

(76) Inventors: Benjamin Stewart, Maroubra (AU); Patricia L. Christen, Piedmont, CA (US); Frederick P. Dillon, IV, San Francisco, CA (US); Nicole Lee Guthrie, San Francisco, CA (US); Ellen Louise LaPointe, Oakland, CA (US); Lalita Kikuyo Suzuki, San Francisco, CA (US); Richard L. Tate, II, Oakland, CA (US); Mark A. Wallace, Redwood City, CA (US); Elizabeth Ji-Eun Song, Palo Alto, CA (US); Daniel E. Cawley, San Francisco, CA (US); Christine B. Brumback, San Francisco, CA (US); Sven D. Newman, Burlingame, CA (US); Rajiv Kantilal Patel, Menlo Park, CA (US); Phong David Ngo, San Francisco, CA (US)

Correspondence Address: SHAY GLENN LLP, 2755 CAMPUS DRIVE, SUITE 210, SAN MATEO, CA, 94403, US

(21) Appl. No.: 12/396,303

(22) Filed: Mar. 2, 2009

Related U.S. Application Data
(60) Provisional application No. 61/032,854, filed on Feb. 29, 2008.
(60) Provisional application No. 61/032,876, filed on Feb. 29, 2008.

(51) Int. Cl. A63F 13/00; A63F 9/24

(52) U.S. Cl. 463/7; 463/31; 463/36

(57) ABSTRACT

Described herein is a game and game system including one or more user motion tracking devices. In some embodiments, a heart rate sensor is also used to monitor the user.

### CROSS-REFERENCE TO RELATED APPLICATIONS

This patent application claims priority to U.S. Provisional Patent Application Ser. No. 61/032,854, filed on Feb. 29, 2008, titled (“TXT IT: A Physical Activity-Promoting Game”) and to U.S. Provisional Patent Application Ser. No. 61/032,876, filed on Feb. 29, 2008, titled (“HONEYCOMB: A Physical Exercise Game”).

### BACKGROUND OF THE INVENTION

Childhood obesity is on the rise both within the United States and throughout the world. This condition poses a serious problem not only for the affected children, but for the burden on public health and the healthcare system at large. Obesity is associated with many co-morbidities, including vascular diseases such as hypertension and heart disease, chronic inflammation, depression and metabolic diseases, such as glucose intolerance, insulin resistance, as well as fall blown type 2 diabetes.

In addition to extensive documentation of the association between childhood obesity and poor health outcomes, a number of studies document the positive effects that physical activity has in reducing the risk of poor health outcomes associated with obesity, including reductions in the development of diabetes and heart disease. Physical activity also helps control weight, promotes psychological well-being, and reduces the risk of premature death. The Centers for Disease Control and Prevention (CDC) recommend that young people engage in at least 1 hour of moderate to vigorous physical activity each day to maintain good health.

While the positive effects of regular physical activity are well documented, motivation to maintain adequate levels of activity over the long term is often lacking. Many young people engage in sedentary behaviors (e.g., watching TV, surfing the Internet) and do not meet the CDC recommendations for physical activity. Research has found that physical activity rates decline with age among young people, with overall levels of physical activity typically beginning to decrease when children are of middle school age.

It is recognized that fun, engaging games or related products that require physical activity can be a way to increase physical activity among young people. To succeed in increasing physical activity, games need to appeal to the target populations and to fit easily within the existing social, educational, and cultural environment.

Accordingly, there is a need in the commercial and healthcare product markets for smart games and related products that address and counter the growing tendency toward sedentary behaviors and that are directed toward the specific goal of increasing the overall level of physical activity of those who play the game or use the product. To succeed in this goal, products need to be easy to use, and have a quick appeal that can also be sustained over the long term. It is further desirable that such products are safe and require minimal adult supervision. Most of all, the games must be effective at their fundamental goal, which is to increase levels of physical activity.

### BRIEF DESCRIPTION OF THE FIGURES

FIG. 1 schematically shows a display and a user standing on an input device of a game according to aspects of the present invention.

FIGS. 2A-2D show various stages of a portion of the display of FIG. 1.

FIGS. 3A-3E show various stages of a hexagon of the display portion of FIGS. 2A-2D.

FIG. 4 schematically shows an exemplary system setup useful for various embodiments disclosed herein.

FIG. 5 shows a virtual pom-pom embodiment.

FIG. 6 shows a communications embodiment.

### INCORPORATION BY REFERENCE

All publications and patent applications mentioned in this specification are herein incorporated by reference in their entirety to the same extent as if each individual publication or patent application was specifically and individually indicated to be incorporated by reference.

### DETAILED DESCRIPTION OF THE INVENTION

The game described herein is directed toward promoting physical activity in a socialized context appropriate for adolescents.

According to aspects of the invention, a fast-paced game of strategy and reflexes is provided that increases the user's heart rate for an extended period of time. The game can appeal to boys, girls and adults all over the world with a non-violent, wholesome premise. In one embodiment, a force-sensitive mat is combined with a wireless heart rate sensor and simple yet exciting puzzle-based game play. With an engaging physical interface, the game follows in the footsteps of classic games such as “Dance Dance Revolution” and “Tetris”, but with an exiting new twist: the speed of the game can adapt to the user's heart rate. The highest scores are achieved by those who maintain an optimal level of exercise throughout a game. A web-based leader board may also be employed to appeal to the burgeoning competitive instinct of adolescents.

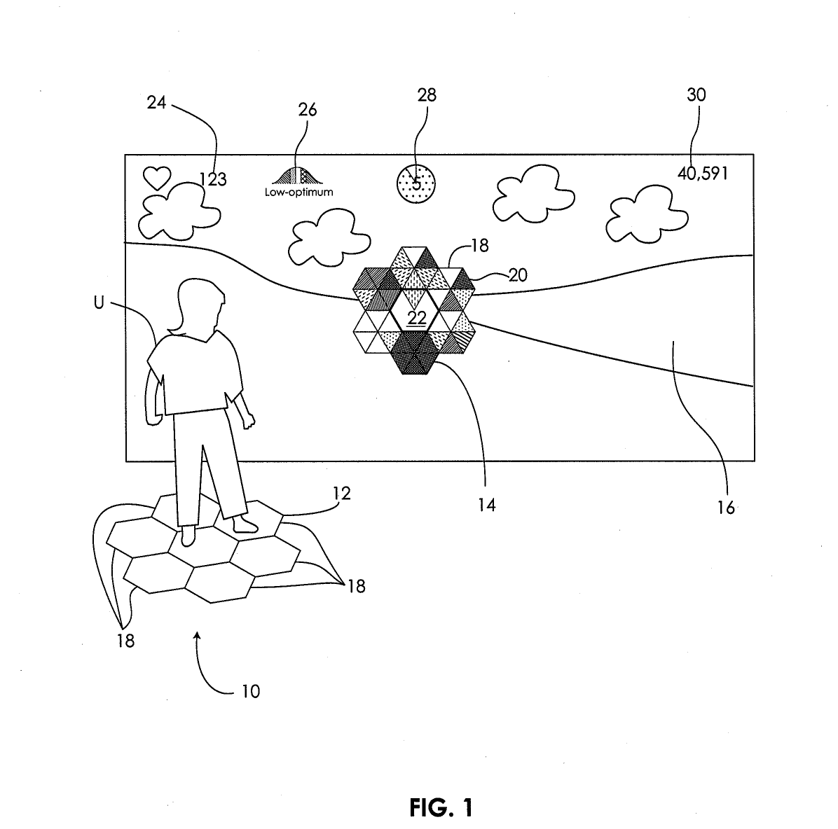

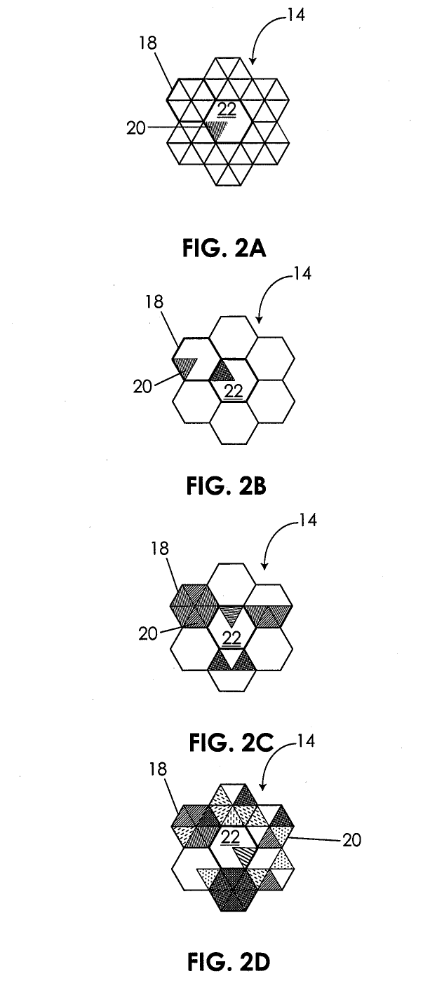

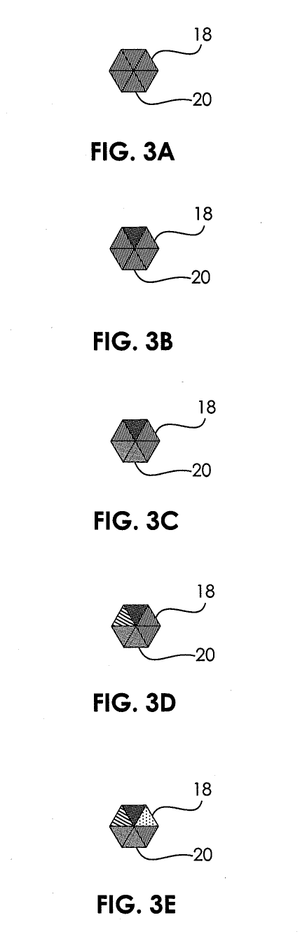

Referring to FIGS. 1, 2A-2D and 3A-3E, an exemplary embodiment of the inventive game is depicted. At a basic level, this embodiment is about sorting things by color and spatial orientation. A honeycomb game board 10 on a game mat 12 (and an associated honeycomb 14 located on display 16) comprises six hexagonal cells 18 or regions arranged in a ring. Each region may be divided into shapes, such as six triangles or slices 20. In the center 22 of the honeycomb 14, a colored slice may be introduced on the display 16 which the user U needs to fit into position in one of the surrounding cells 18. Users simply step, hop or jump to the cell 18 of their choosing. Maximum points may be scored if users complete a cell 18 with all of its slices 20 being of the same color. The cells 18 quickly fill up, and the entire honeycomb 14 resets if a user does not position the current slice 20 after a certain amount of time. This time period may be based on the user's current heart rate. For the best possible score, a user will want the honeycomb 14 to reset relatively quickly. Users will need to maintain an optimal heart rate for a faster paced game. Games will slow down if a user's heart rate drops below or rises above an optimal range. In one embodiment, the game is divided into five rounds of five minutes each, with a new color slice 20 being introduced in every round, up to a maximum of five colors in the final round.

A user's heart rate, as depicted by reference numeral 24, may be continuously displayed on the display screen 16. A maximum and/or minimum heart rate (not shown) may also be displayed. An optimum heart rate range graphic 26 may also be displayed, with an indicator and/or text displayed to show the user where in the range their heart rate currently is. Round indicator 28 may be displayed on the display screen to indicate which round is currently being played, such as round 5 of 5 in the embodiment shown. Points accumulated 30 may also be displayed.

In alternative embodiments, the six honeycomb regions or cells described above may be replaced with any number of circles, squares, triangles or other shapes forming a ring or a portion of a ring around the user on the mat. Similarly, the triangle shapes for sorting may also be replaced with other shapes. In some embodiments, game mat 12 is replaced with a printed, projected, or otherwise non-pressure sensitive image. The user's movements are instead tracked with other means, such as the motion tracking devices described below.

The rules of the game are simple, but it will require strategy, fast reflexes, and physical fitness to truly master. At the end of every game, an encrypted code may be provided allowing users to enter their score on a central game website. Alternately, if available, scores may be directly uploaded via the internet. Users can see how their scores stack up against their friends, or the world at large. Users will be able to compete for the honor of being named champion of their neighborhood, city, state, country or world. In some embodiments, users can play against others, either in the same physical space or online. In some embodiments, two or more users can see the same screen or game board, and whoever moves the piece in play the fastest earns the points for that piece.

In some embodiments, the game can be a self-contained device that plugs directly into a television or monitor. In some embodiments, a custom input device or devices may be designed for coupling with a console or personal computer. A game mat can use electrical contact, pressure or proximity sensing to determine a user's actions. The game mat may be wired to or connect wirelessly with other components of the game. Other sensors may be employed to determine a user's foot movements. A wired or wireless heart rate sensor can be based on a number of off-the-shelf solutions that take heart rate readings from the wrist, finger, chest, earlobe or other location of the user.

With fast-moving game play that requires users to step, hop, and jump around the game mat to score points, the game can provide an intensive, full-body workout that also helps improve reflexes and coordination. By linking the game mechanism to a user's heart rate, kids are encouraged to play at an optimum level of physical activity. In some embodiments, the game calculates the optimum exercise range based on the exact age of a user and their heart rate at rest. For example, for a typical 12 year-old this range would be roughly 140 to 160 beats per minute. As kids become more fit over time, they need to step up their physical intensity to maintain this optimum heart rate. The fan nature of the game makes it likely that kids will play more than one game in a session. The game may be configured to provide a warning if users start overexerting themselves.

In one embodiment, a user's baseline heart rate may be identified during game play or from history recorded and stored in a memory function of the game controller. A user's age, weight, fitness level and/or other parameters may be entered and used in the control of the game. The controller may establish a handicap system for game play that can be calibrated to the user's fitness level.

In another embodiment, the device may also play music during play. The rhythm of the music may increase or decrease dynamically in relation to the increase or decrease of the user's heart rate.

According to other aspects of the invention, a Software Development Kit (SDK) may be provided to allow “homebrew” developers (including kids themselves) to create their own games using a game mat and/or heart rate sensor. Such games can instill in kids the virtues of an intensive, cardiovascular workout. The games add a fan element that is missing on traditional exercise equipment such as treadmills and exercise bikes.

The inventive game provides a safe exercise experience that can be enjoyed by kids from the comfort of their own home. It may be played alone or with others. It puts kids in complete control of their own exercise fun. The game may be configured to provide a warning if users start overexerting themselves. Many parents have a concern about the amount of time some kids spend playing video games. With many embodiments of the game described above, the problematic addition is eliminated because the intense, physical nature of the game imposes a natural limit on how much kids can play in a day.

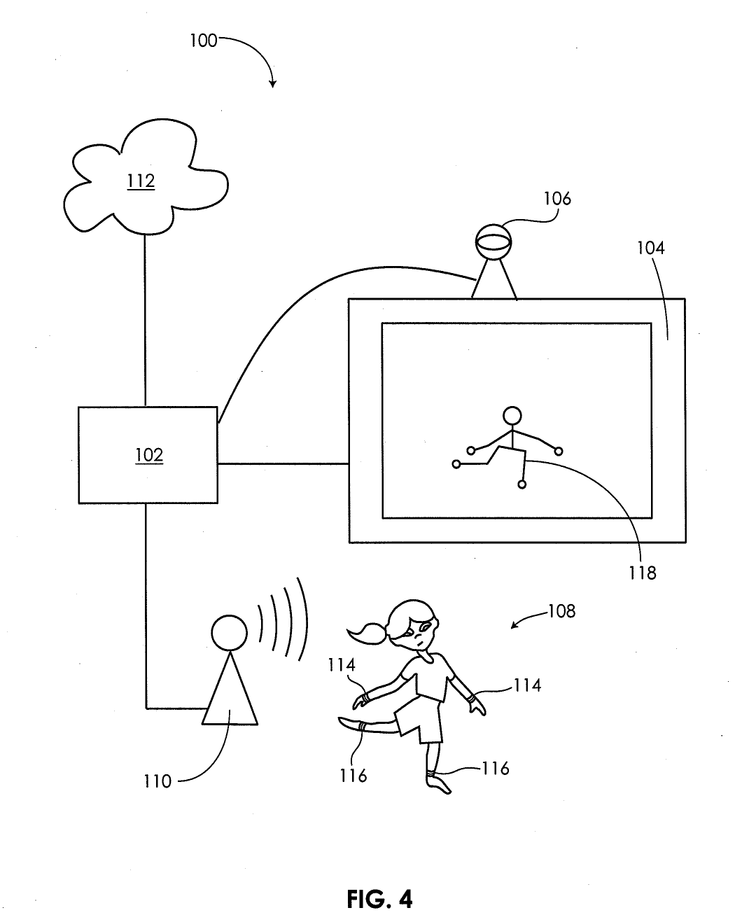

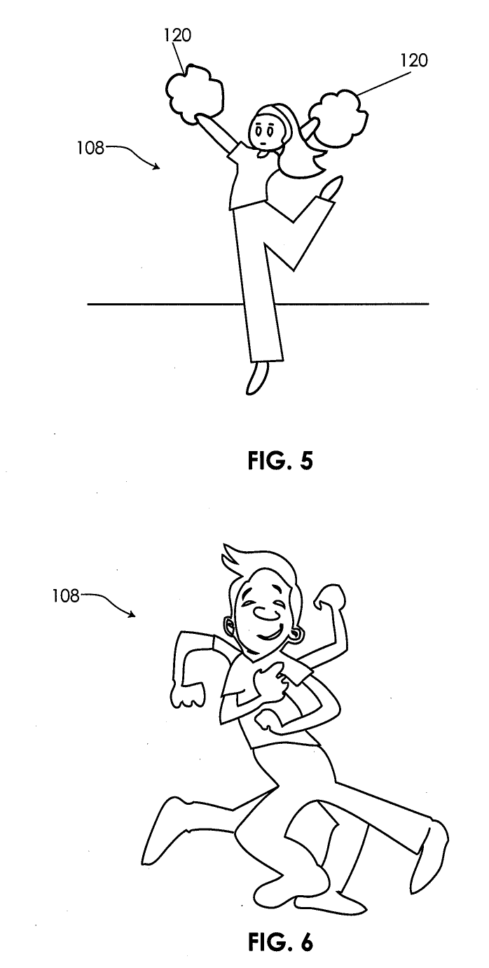

Referring now to FIGS. 4-6, other embodiments of a physical exercise game according to aspects of the present description are shown. These embodiments utilize motion tracking hardware and/or software, in addition to or instead of the force sensitive mat and heart rate sensor described above, to monitor a user's movements. These movements may be made in conjunction with the shape sorting game described above, or with dancing, texting, physical communicating, virtual world, or other games as described below.

FIG. 4 schematically depicts an exemplary hardware setup used in some of the following embodiments. Game system 100 includes a game console 102 electronically connected to a television set or video monitor 104. A camera 106 may be located adjacent to monitor 104 and electronically connected to console 102 for tracking the motion of user 108. Instead of or in addition to camera 106, a radio receiver antenna 110 may be electronically connected to console 102 for use in motion tracking. Console 102 may also be provided with a wired or wireless communication port for connecting to the Internet 112.

Camera 106, such as an inexpensive, off-the-shelf “webcam” or an infrared camera, may be used to track the motion of user 108. To aid in tracking the motion of user 108, passive or active markers may be worn by the user 108. Such markers are configured to be more easily tracked by camera 106, or by another motion tracking device. For example, bracelets 114 and anklets 116 may comprise unique colors, patterns or materials to aid in tracking user 108. Other examples of suitable passive markers include a necklace, a cap, a belt, a band, reflective tape, gloves, and radio frequency identification (RFID) tags (not shown). In one embodiment of the invention, gloves are worn on both hands, with each glove comprising a different color. Active markers such as infrared or Blue Tooth transmitters (not shown) may also be used. The tracking markers may be incorporated into styled accessories that appeal to young users.

Signals from camera 106 and/or antenna 110 are fed into console 102 for processing. Based on these signals, console 102 is able to create a simulation of the movements of user 108 for realtime display on monitor 104 and/or for recording for later playback. The simulated movements make take the form of a simple stick FIG. 118, a complex avatar, or anything in between. This arrangement provides an interactive game that makes a virtual character 118 come alive as user 108 dances.

In some embodiments, the user is allowed to choose music, record his or her moves, and share a virtual dance video with others online. According to aspects of the invention, group dances may be created. Users may test their skills by mimicking videos from other users. The other users may use the same console 102, other consoles connected online, or dance videos superimposed on monitor 104. Dance videos created with the type of system described above may be posted to an online website where others may view them and vote for their favorites.

Referring to FIG. 5, a variation of the system described above is depicted. Virtual pom-poms 120, drum sticks, batons, musical instruments and other items may be shown in a dance video. Such an arrangement is ideal for young users who are passionate about cheer, drill, or drum corps. Pom-poms 120 and similar items may be completely virtual (only existing on monitor 104), or passive or active items may be held by the user in a similar manner to the motion tracking markers described above. Users may create movements individually or with a team. Teams can use this arrangement to practice their routines together online.

Referring to FIG. 6, another variation of the system described above is depicted. In this embodiment, a user may communicate with other users by using their whole body as a communication tool. Similar to text messaging, a user can quickly move between various positions, each having a predetermined meaning. For example, a particular position or gesture can signify a letter, number or an entire phrase or sentence. User movements picked up by tracking device 106 and/or 110 are fed into game console 102. These movements may be translated into text or other characters by console 102, or transmitted as they are through the online connection to other users. In this manner, one or more conversations may be carried on simultaneously by a user. In other embodiments, the tracked movements of user 108 can be used to control the movement of online characters and objects. For example, behavior of user 108 may be replicated in a virtual world. In some embodiments, tracking markers such as those described above may be used to assist the motion tracking device(s). In other embodiments, the natural movements of the user may be detected without the use of markers. Existing code libraries may be utilized for defining the gestures recognized by the system, or new gesture definitions may be created. Code libraries that currently exist recognize basic gestures with natural movements in various programming languages, including the Flash version that is current at the time of this filing.

In other embodiments, the game system may be configured to allow game play similar to that of the traditional game of “Twister”. Shapes, colors, positions, gestures and/or other instructions may be provided to one or more users from monitor 104, requiring the user(s) to move quickly in response. Feedback of user movements to console 102 may be provided by a pressure sensitive mat or by other motion detecting devices as described above. Points may be awarded to user(s) based on speed and accuracy. The game system described above may also be configured to play other games such as Tetris, where the user must use their whole body to place puzzle pieces. The above games can be designed to keep activity levels high. Other exercise or dance instructions may also be provided by monitor 104. Feedback from user movements can control the pace of the exercise or instruction, and can direct the system to automatically focus on problem areas a user is having with the routines. The heart rate monitor discussed above may also be utilized to provide similar feedback control of the system, and/or such data may be displayed and recorded.

In other embodiments, the game system may be incorporated in a personal computer, or may comprise a cartridge or disc played on a standard gaming console. In some of these embodiments, software for running the game, interpreting marker movements, and/or natural gestures is a desktop/client application. In other embodiments, this software is a web/server application. In yet other embodiments, the game system may be connected to a cell phone to provide communications with other users. The connected may be wired, or a wireless connection such as one using the Blue Tooth wireless standard.

While the devices and methods for using them have been described in some detail here by way of illustration and example, such illustration and example is for purposes of clarity of understanding only. It will be readily apparent to those of ordinary skill in the art in light of the teachings herein that certain changes and modifications may be made thereto without departing from the spirit and scope of the invention.

What is claimed is:

1. A motion-based game comprising:
a controller configured to control a game and to output signals to a video display;
a heart rate sensor responsive to a heart rate of a game user and operably connected to the controller; and
an input device operably connected to the controller;
wherein the controller is configured to cause a series of objects to be displayed on a video display, wherein the input device and controller are configured to allow a user to respond to the objects displayed on the video display by sorting the objects, and wherein the controller is configured to change at least one game parameter based on a heart rate sensed by the heart rate monitor.

2. The game of claim 1 wherein the input device comprises a pressure-sensitive mat.

3. The game of claim 2 wherein the mat comprises a plurality of regions corresponding to groups that the objects can be sorted into.

4. The game of claim 3 wherein the regions are radially spaced around a central portion.

5. The game of claim 4 wherein the regions comprise six hexagons in a ring formation, with each hexagon sharing two common sides with two adjacent hexagons.

6. The game of claim 1 wherein the heart rate sensor is wirelessly connected to the controller.

7. The game of claim 1 wherein the at least one game parameter comprises a quantity of points being awarded to the user.

8. The game of claim 1 wherein the at least one game parameter comprises a rate at which the objects are displayed.

9. The game of claim 1 wherein the controller is configured to change the at least one game parameter when the user's heart rate rises above a predetermined value.

10. The game of claim 1 wherein the controller is configured to change the at least one game parameter when the user's heart rate drops below a predetermined value.

11. The game of claim 1 wherein the controller is configured to change the at least one game parameter when the user's heart rate rises above or drops below an optimal range.

12. The game of claim 1 wherein the objects to be sorted are triangles.

13. The game of claim 12 wherein the controller and input device are configured to allow the triangles to be sorted into a plurality of hexagons.

14. A game comprising:
a controller configured to control a game and to output signals to a video display;
an input device responsive to movements of a user's feet;
wherein the controller is configured to cause a series of objects to be displayed on a video display, wherein the input device and controller are configured to allow a user to respond to the objects displayed on the video display by sorting the objects.

15. The game of claim 14 wherein the input device comprises a pressure-sensitive mat.

16. The game of claim 15 wherein the mat comprises a plurality of regions corresponding to groups that the objects can be sorted into.

17. The game of claim 16 wherein the regions are radially spaced around a central portion.

18. The game of claim 17 wherein the regions comprise six hexagons in a ring formation, with each hexagon sharing two common sides with two adjacent hexagons.

19. The game of claim 14 wherein the objects to be sorted are triangles.

20. The game of claim 19 wherein the controller and input device are configured to allow the triangles to be sorted into a plurality of hexagons.

21. A method of operating a game comprising:
displaying on a display screen an object to be sorted;
receiving input from a user input device indicating a position of at least one foot of the user;
sorting the object into one of a plurality of groups based on the input received;
showing the object in its associated group on the display screen; and
repeating the displaying, receiving, sorting, and showing steps a plurality of times.

22. The method of claim 21, wherein the method is controlled by a device coupled to a television.

23. The method of claim 21, wherein the method is controlled by a personal computer and wherein the user input device is coupled to the computer.

24. The method of claim 21 wherein the input device comprises a pressure-sensitive mat.

25. The method of claim 24 wherein the mat comprises a plurality of regions corresponding to the groups that the objects can be sorted into.

26. The method of claim 25 wherein the regions are radially spaced around a central portion.

27. The method of claim 26 wherein the regions comprise six hexagons in a ring formation, with each hexagon sharing two common sides with two adjacent hexagons.

28. The method of claim 21, further comprising measuring a user's heart rate and displaying the heart rate on the display screen.

29. The method of claim 21, further comprising measuring a user's heart rate and changing operation of the game based on the measured heart rate.

30. The method of claim 29, further comprising calibrating the rate that music is playing with the user's heart rate.

31. The method of claim 29 wherein the changing operation comprises awarding a quantity of points to the user based on the measured heart rate.

32. The method of claim 29 wherein the changing operation comprises varying a speed of the game based on the measured heart rate.

33. The method of claim 29 wherein the operation of the game is changed when the user's heart rate rises above a predetermined value.

34. The method of claim 29 wherein the operation of the game is changed when the user's heart rate drops below a predetermined value.

35. The method of claim 29 wherein the operation of the game is changed when the user's heart rate rises above or drops below an optimal range.

36. The method of claim 21 wherein the objects being sorted are triangles.

37. The method of claim 36 wherein the triangles are sorted into a plurality of hexagons.

38. A motion-based game comprising:
a controller configured to control a game and to output signals to a video display;
a heart rate sensor responsive to a heart rate of a game user and operably connected to the controller; and
a user motion tracking device operably connected to the controller, wherein the controller is configured to receive signals from the motion tracking device to create a simulation of the user's motion to be displayed on a video display, and wherein the controller is configured to change at least one game parameter based on a heart rate sensed by the heart rate monitor.

39. The game of claim 38 further comprising a pressure-sensitive mat operably connected to the controller, the mat being configured to provide signals to the controller to aid in creating the simulation of the user's motion.

40. The game of claim 38 further comprising at least one marker device configured to be worn by the user and to aid the tracking device in tracking the motion of the user.

41. The game of claim 40 wherein the at least one marker device is passive.

42. The game of claim 41 wherein the at least one marker device is selected from the group consisting of a bracelet, an anklet, a necklace, a cap, a belt, a band, reflective tape, and a glove.

43. The game of claim 41 wherein the at least one marker device comprises two gloves, each glove comprising a different color.
